(19) United States
(12) Patent Application Publication
(10) Pub. No.: US 2026/0143108 A1
(43) Pub. Date: May 21, 2026

(54) SIMPLIFICATION OF MODEL PARAMETER DERIVATION

(71) Applicant: Tencent America LLC, Palo Alto, CA (US)

(72) Inventors: Tianqi LIU, Palo Alto, CA (US); Liang ZHAO, Palo Alto, CA (US); Madhu PERINGASSERY KRISHNAN, Palo Alto, CA (US); Ting-Lan LIN, Palo Alto, CA (US); Jayasingam ADHURAN, Palo Alto, CA (US); Shan LIU, Palo Alto, CA (US)

(21) Appl. No.: 19/366,481

(22) Filed: Oct. 22, 2025

Related U.S. Application Data
(60) Provisional application No. 63/722,547, filed on Nov. 19, 2024.

(51) Int. Cl. H04N 19/105; H04N 19/159; H04N 19/176

(52) U.S. Cl. CPC H04N 19/105; H04N 19/159; H04N 19/176

(57) ABSTRACT

An example method of video coding includes receiving a video bitstream comprising a plurality of blocks, including a current block. The method also includes determining that a multi-hypothesis cross component prediction (MHCCP) mode is enabled for the current block, and identifying a reference area for the MHCCP mode. The method further includes subsampling the reference area, and applying the MHCCP mode to the current block using the subsampled reference area.

### PRIORITY AND RELATED APPLICATIONS

This application claims priority to U.S. Provisional Patent Application No. 63/722,547, entitled “Simplification of Model Parameter Derivation,” filed Nov. 19, 2024, which is hereby incorporated by reference in its entirety.

### TECHNICAL FIELD

The disclosed embodiments relate generally to video coding, including but not limited to systems and methods for processing video data using sampling and cross-component prediction.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes, amongst other things, prediction of video data using a cross-component prediction (CCP) mode where each of a plurality of samples of a second color component of a current coding block is determined based on one or more associated samples of a first color component of a reference block. The CCP mode may use a multi-tap model that includes a number of taps. As an example, a sub-sampling of reference samples may be used for a CCP mode (e.g., a multi-hypothesis cross-component prediction (MHCCP) mode). Subsampling the reference area can reduce the hardware complexity (e.g., smaller buffer size) and can reduce the complexity of the CCP parameter derivations.

In accordance with some embodiments, a method of video decoding includes: (i) receiving a video bitstream comprising a plurality of blocks, including a current block; (ii) determining that a MHCCP mode is enabled for the current block; (iii) identifying a reference area for the MHCCP mode; (iv) subsampling the reference area; and (v) applying the MHCCP mode to the current block using the subsampled reference area.

In accordance with some embodiments, a method of video encoding includes (i) receiving video data comprising a plurality of blocks, including a current block; (ii) determining that an MHCCP mode is enabled for the current block; (iii) identifying a reference area for the MHCCP mode; (iv) subsampling the reference area; and (v) applying the MHCCP mode to the current block using the subsampled reference area.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4 illustrates an example scheme for generating a first chroma sample from one or more luma samples in a CCP mode in accordance with some embodiments.

FIG. 5A is a diagram of an example image frame including a current block located at a top boundary of a superblock in accordance with some embodiments.

FIG. 5B is a diagram of an example image frame including a current block located at a left boundary of a superblock in accordance with some embodiments.

FIG. 5C illustrates an example reference area for a coding block in accordance with some embodiments.

FIGS. 5D-5I illustrate example subsampling of the example reference area in accordance with some embodiments.

FIG. 6A is a diagram of applying a plurality of filter shapes to a current block in accordance with some embodiments.

FIG. 6B illustrates an example syntax when an enable MHCCP flag is on in accordance with some embodiments.

FIG. 7A illustrates an example video decoding process in accordance with some embodiments.

FIG. 7B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video compression methods using intra prediction and inter prediction. Samples of a current coding block may be reconstructed from samples of a reference coding block based on a model having a plurality of model parameters. For example, when determining that a CCP mode is enabled for the current block, a reference area may be identified for the CCP mode. The reference area may be subsampled, and the CCP mode may be applied to the current block using the subsampled reference area. In this way, the complexity and memory requirements for using the reference samples may be reduced.

The present disclosure describes, amongst other things, a set of methods for simplifying model parameter derivation in video coding, particularly within MHCCP modes. In some embodiments, subsampling techniques are applied to the reference area used for model parameter calculation. By selectively reducing the number of reference samples (e.g., such as employing a subsampling rate of r=1/N, quincunx down-sampling, or varying the subsampling rate across different rows, columns, or regions), the computational complexity and hardware requirements may be simplified for both encoding and decoding processes. For example, more aggressive subsampling can be applied to regions further from the current block, or the subsampling ratio can be adapted based on block shape and size, ensuring efficient use of memory and processing resources. Additionally, irregular sampling methods, pooling, and/or low-pass filtering may be applied to further optimize reference sample selection. These techniques collectively result in smaller buffer sizes, reduced memory bandwidth, and faster parameter derivation, thereby enabling more efficient hardware implementations and lowering power consumption. The benefits are evident in improved coding efficiency, reduced encoding and decoding times, and enhanced scalability for devices with limited resources, as demonstrated by simulation results (e.g., Table 1 below) showing minimal impact on video quality while achieving substantial reductions in complexity.

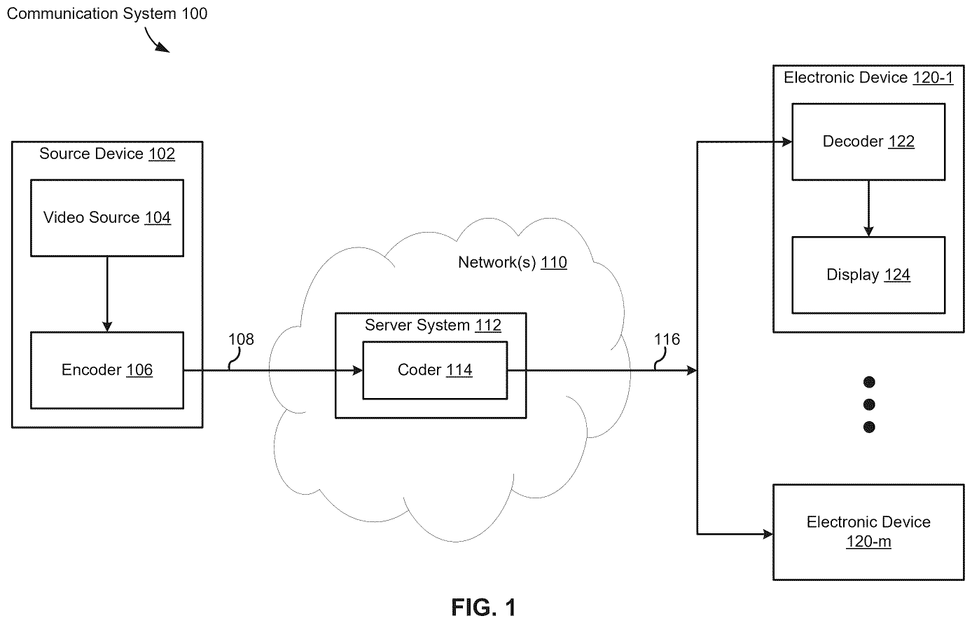

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

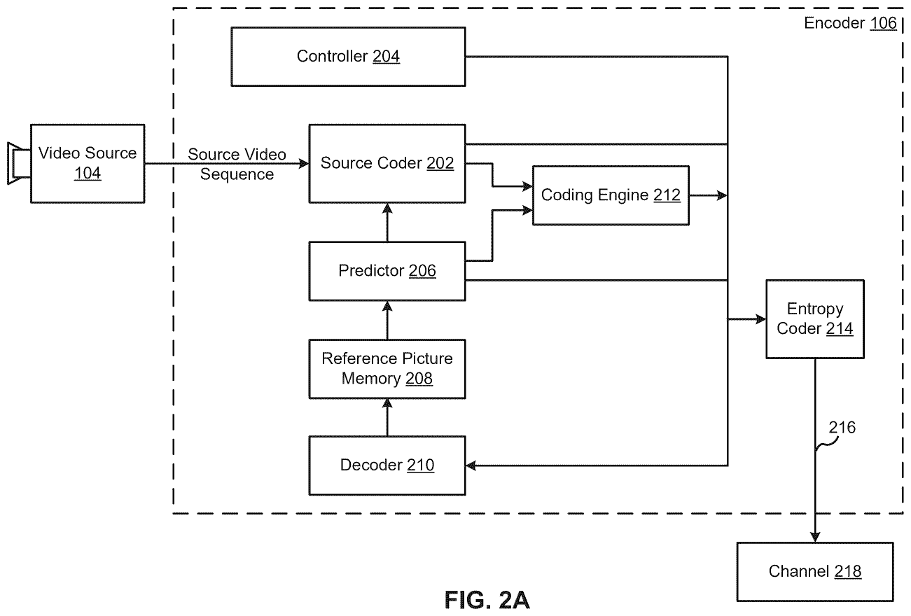

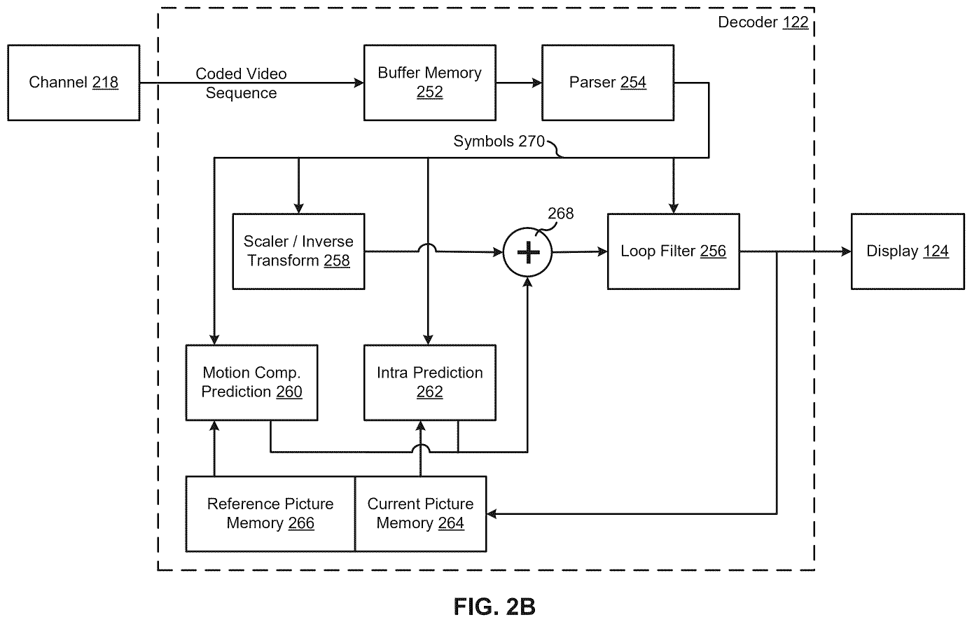

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

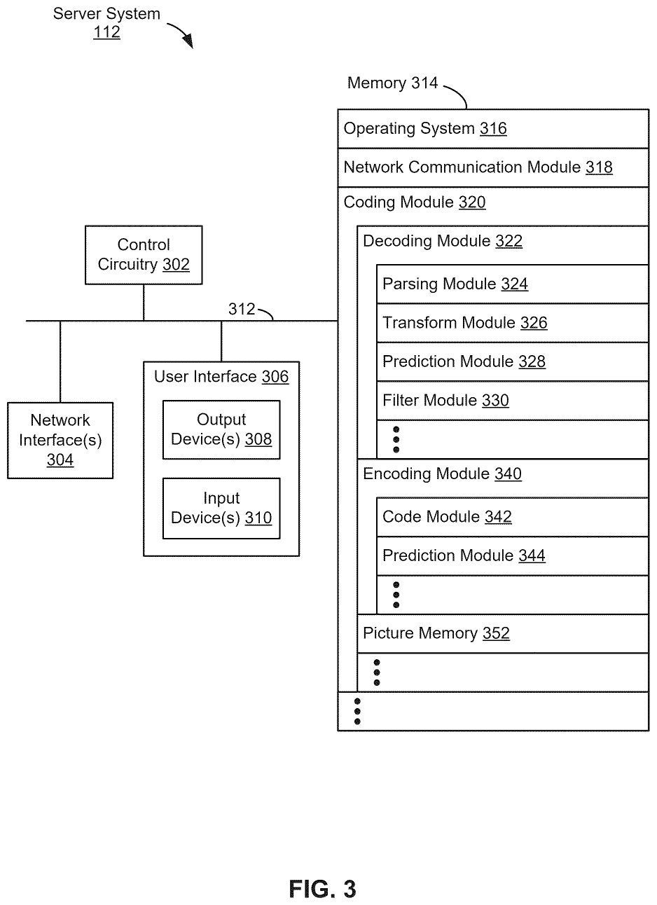

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The user interface 306 includes one or more output devices 308 and/or one or more input devices 310. The input device(s) 310 may include one or more of: a keyboard, a mouse, a trackpad, a touch screen, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

The coding processes and techniques described below may be performed at the devices and systems described above (e.g., the source device 102, the server system 112, and/or the electronic device 120). According to some embodiments, methods for signaling, parsing, and using cross-component prediction modes are described below.

The methods described herein can be applied to intra or inter prediction modes using a model based on least mean square optimization, with the model parameter derived by the neighboring reconstructed samples of the current block and reference block. For a first example, the intra prediction mode can be a cross-component prediction mode which derives the prediction samples of a first color component using the reconstruction samples of a second color component, while the current block can be a chroma block and the reference block can be a co-located luma block. For a second example, the intra prediction mode can be an intra block copy or intra template matching mode, which derives the prediction samples of the current block using a block vector that can be signaled (e.g., intra block copy) or implicitly derived (e.g., using template matching), while the reference block is block identified by the block vector. For a third example, the inter prediction mode can be an illumination compensation mode, which derives the prediction samples using the neighboring reconstruction samples of the current block and the reference block in the reference frame based on a least mean square optimization.

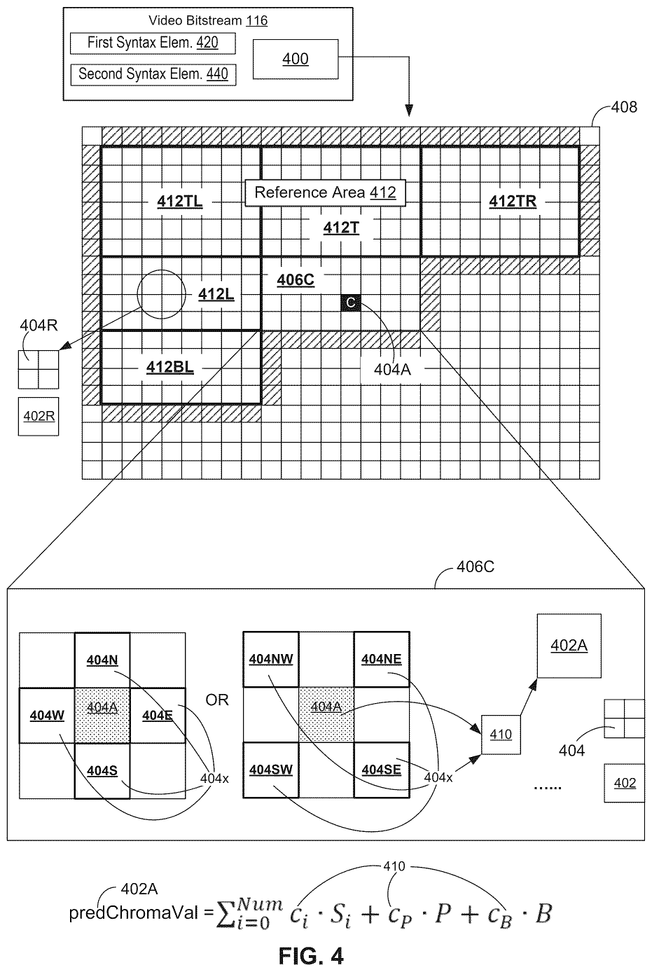

FIG. 4 illustrates an example scheme 400 for generating a first chroma sample 402A from one or more luma samples 404 (e.g., 404A and 404X) in a CCP mode (e.g., a multi-hypothesis CCP (MHCCP) mode), in accordance with some embodiments. In some embodiments, a video bitstream 116 includes a current coding block 406C of the current image frame 408 and a syntax element 420 for the CCP mode. The syntax element 420 indicates whether to reconstruct the first chroma sample 402A of the current coding block 406C based on a set of one or more luma samples 404 of a reference coding block based on a plurality of model parameters 410. Referring to FIG. 4, in an example, the reference coding block is the current coding block 406C itself. In some embodiments, the syntax element 420 is signaled in the video bitstream 116 at one of a block level, a superblock level, an image frame level, a slice level, a tile level, and an image sequence level for the current coding block 406C.

In some embodiments (FIG. 4), the CCP mode comprises a cross-component intra prediction (CCIP) mode, and a current coding block 406C of a current image frame 408 is coded in the CCIP mode. In the CCIP mode, the current coding block 406C includes a chroma block, and corresponds to a reference coding block including a co-located luma block. A decoder 122 (FIG. 2B) determines each of a plurality of chroma samples 402 of the current coding block 406C based on one or more luma samples 404 of the reference coding block that have been reconstructed. In some situations, the CCIP mode includes a cross-component linear model (CCLM) mode in which a first chroma sample 402A is converted from a reconstructed luma sample 404A that is co-located with the chroma sample 402A based on a linear model. Alternatively, in some situations, the CCIP mode includes a convolutional cross-component mode (CCCM) in which a first chroma sample 402A is predicted directly from a plurality of reconstructed luma samples 404X that is located adjacent to the first luma sample 404A based on a filter shape of a filter. Alternatively and additionally, in some situations, the CCIP mode includes the MHCCP mode in which a first chroma sample 402A is generated by combining at least the first luma sample 404A that is collocated with the first chroma sample 402A and a plurality of hypothesis values using a plurality of weighing factors. The plurality of neighboring luma samples 404X of the first luma sample 404A are combined using a plurality of coefficients to generate the plurality of hypothesis values. Stated another way, in the MHCCP mode, the first luma sample 404A and the plurality of neighboring luma samples 404X are combined using a plurality of model parameters 410 (which are associated with the weighing factors and the coefficients) to generate the first chroma sample 402A. The first chroma sample 402A is a blue-difference chroma (Cb) sample or a red-difference chroma (Cr) component.

In some embodiments, a video bitstream 116 includes a syntax element 420 for an MHCCP mode. The first chroma sample 402A of the current coding block 406C is configured to be generated by combining at least the first luma sample 404A that is co-located with the first chroma sample 402A and one or more neighboring luma samples 404X of the first luma sample 404A using a plurality of model parameters (e.g., ci, cP, cB). In accordance with a determination that the MHCCP mode is applied, the first chroma sample 402A is predicted according to the following model:

$$\begin{matrix}Equation 1 - Example Chroma Prediction for MHCCP & \\ pred Chroma Val = {\sum }_{i = 0}^{Num} {c}_{i} \cdot {S}_{i} + {c}_{P} \cdot P + {c}_{B} \cdot B & \end{matrix}$$

where predChromaVal is a predicted chroma value of the first chroma sample 402A; Num is a total number of neighboring luma samples 404X; S, is a luma value of the first luma sample 404A (where i is equal to 0) or a neighboring luma sample 404X (where i is greater than 0), which is indexed by i; P is a nonlinear term; B is an offset term; and cᵢ, c_{P}, c_{B} are model parameters. In an example, the nonlinear term P is equal to equal to (C×C+B)>>bit_depth, where C is a sample value of the first luma sample 404A, and bit depth is the number of bits needed to represent luma samples of the current image frame 408 during encoding and decoding. In some embodiments, B is a median luma value, a middle luma value, or an average luma value of the luma samples 404 of the current coding block 406C. In another example, B is equal to 1<<(bit depth-1). In the MHCCP mode, the chroma samples 402 of the current coding block 406C do not need to be transmitted in the video bitstream 116, thereby conserving a communication bandwidth of a video codec.

In some embodiments, each of the one or more neighboring luma samples 404X of the first luma sample 404A is immediately adjacent to, and shares at least one respective side or vertex with, the first luma sample 404A. In some embodiments, the one or more neighboring luma samples 404X include a subset or all of a north neighboring luma sample (also called a top luma sample) 404N, a south neighboring luma sample (also called a bottom luma sample) 404S, a west neighboring luma sample (also called a left luma sample) 404W, an east neighboring luma sample (also called a right luma sample) 404E, a northwest neighboring luma sample (also called a top left luma sample) 404NW, a southeast neighboring luma sample (also called a bottom right luma sample) 404SE, a southwest neighboring luma sample (also called a bottom left luma sample) 404SW, and a northeast neighboring luma sample (also called a top right luma sample) 404NE.

In some embodiments, Equation 1 includes five terms, and represents a five tap model for determining the first chroma sample 402A of the current coding block 406C based on three linear terms (e.g., associated with the first luma sample 404A and neighboring luma samples 404W and 404E), the nonlinear term P, and the offset term B in the MHCCP mode. Alternatively, in some embodiments, equation (1) includes seven terms, and represents a seven tap model for determining the first chroma sample 402A of the current coding block 406C based on three linear terms (e.g., associated with luma samples 404A, 404W, 404E, 404N, and 404S), the nonlinear term P, and the offset term B in the MHCCP mode.

In some embodiments, luma samples 404 and chroma samples 402 of the current coding block have different resolutions corresponding to a chroma subsampling scheme (e.g., 4:2:2 or 4:2:0).

In some embodiments, the plurality of model parameters cᵢ, c_{P}, and c_{B} are determined based on a set of one or more reference luma samples 404R and a set of one or more co-located reference chroma samples 402R within a reference area 412 of the current coding block 406C. The reference area 412 is located in the current image frame 408. Further, in some embodiments, the reference luma samples 404R of the reference area 412 are combined to re-generate one or more chroma samples 402A based on equation (1). In some embodiments, the set of one or more co-located reference chroma samples 402R and the one or more re-generated chroma samples are compared to generate a least mean square (LMS) value. The plurality of model parameters cᵢ, c_{P}, c_{B} are iteratively adjusted to reduce the LMS value, until the LMS value satisfies a predefined criterion (e.g., in which the LMS value is below a threshold LMS value or is minimized).

In some embodiments, the plurality of model parameters cᵢ, c_{P}, or c_{B} are at least partially derived based on chroma samples and luma samples within the reference area 412 of the current coding block 406C, and the reference area 412 includes one or more coding blocks (e.g., 4 coding blocks in FIG. 4) that are decoded prior to, the current coding block 406C. In some embodiments, a subset of the one or more coding blocks is immediately adjacent to the current coding block 406C. In some embodiments, a subset of the one or more coding blocks are separated from the current coding block 406C by one or more coding blocks. In some embodiments, the reference area 412 includes at least a portion of one or more rows above the current coding block 406C and/or a portion of one or more columns to the left of the current coding block 406C. For example, referring to FIG. 4, the reference area 412 includes seven rows of luma samples 404R above the current coding block 406C and nine columns of luma reference samples 404R to the left of the current coding block 406C. The reference area 412 may include a padded row and a padded column (e.g., shaded in FIG. 4).

Additionally, in some embodiments, the reference area 412 of the current coding block 406C includes one or more of: a top left reference region 412TL, a top reference region 412T, a top right reference region 412TR, a bottom left reference region 412BL, and a left reference region 412L. In an example, the reference area 412 includes the top reference region 412T and the left reference region 412L. Each of the reference regions includes one or more coding blocks. Stated another way, in some embodiments, the reference area 412 includes at least a portion of a plurality of rows above the current coding block 406 and/or a portion of a plurality of columns to the left of the current coding block 406. For example, referring to FIG. 4, the reference area 412 includes a first portion of 6 rows of chroma samples above the current coding block 406C and a second portion of 8 columns of chroma samples to the left of the current coding block 406C. A column number of the first portion is determined by a column number of the current coding block 406C, and a row number of the second portion is determined by a row number of the current coding block 406C. In some embodiments, the reference area 412 extends one coding block width to the right of a right boundary of the current coding block 406, and one coding block height below a bottom boundary of the current coding block 406. In some embodiments, the reference area 412 is adjusted to include only available samples. Extensions 412E to the reference area 412 are padded in unavailable areas to provide side samples of a filter.

In some embodiments, the reconstructed luma samples 404R and chroma samples 402R of the reference area 412 are used to generate the model parameters in the CCP mode. The reference area 412 may be L-shaped, including bottom left, left, top left, above and above right reference regions. For example, the reference area 412 has a first integer number K (e.g., 6) of reference lines above the current coding block 406C and a second integer number L (e.g., 8) columns to the left of the current coding block 406C. Extensions 412E to the reference area 412 include padded pixels for the reference samples.

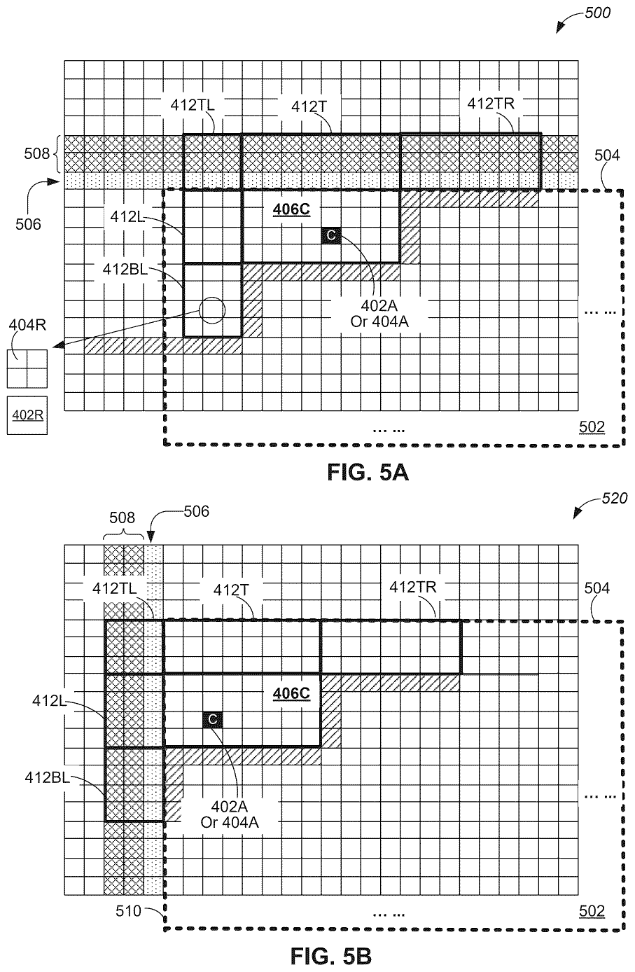

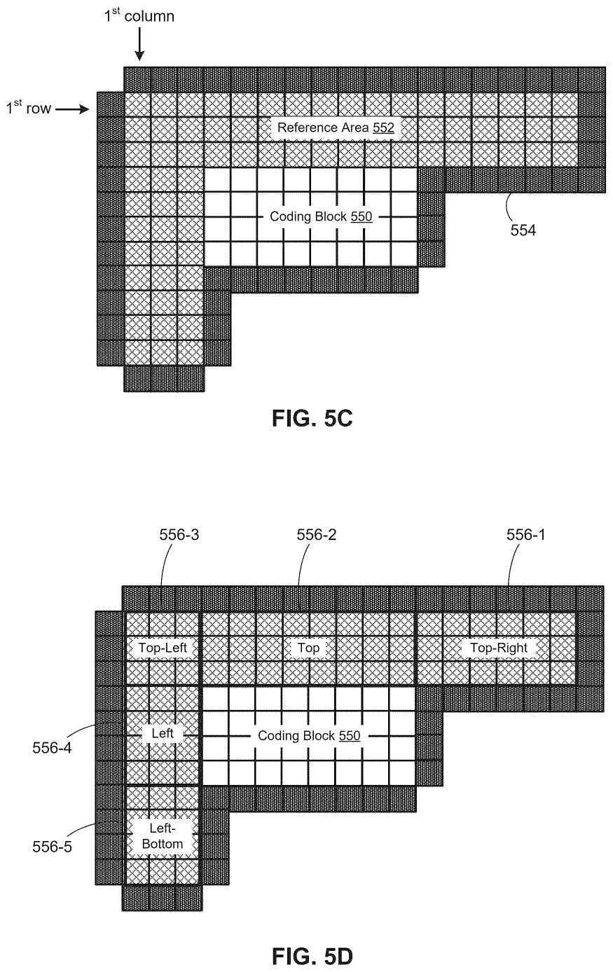

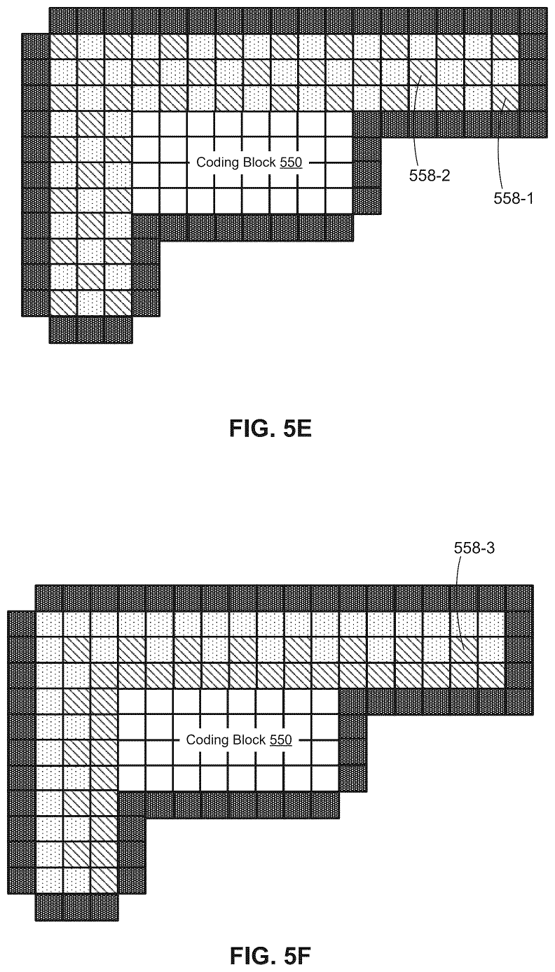

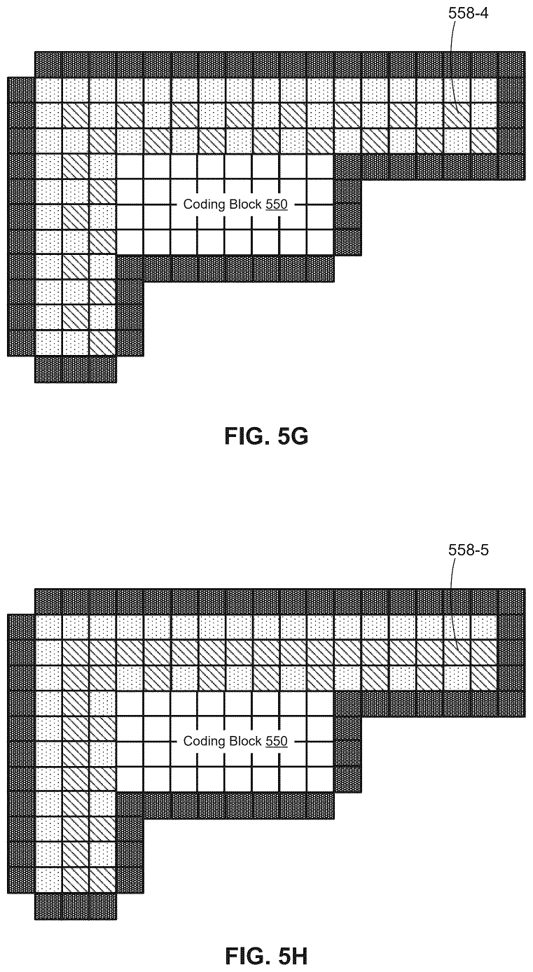

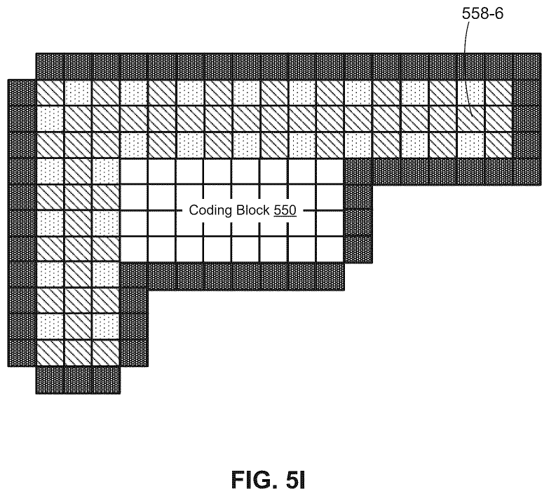

FIG. 5A is a diagram of an example image frame 500 including a current coding block 406C located at a top boundary 504 of a superblock 502, in accordance with some embodiments, and FIG. 5B is a diagram of an example image frame 520 including a current coding block 406C located at a left boundary 510 of a superblock 502, in accordance with some embodiments. In an MHCCP mode, the current coding block 406 is reconstructed based on model parameters 410 determined based on reference samples 402R and 404R of a reference area 412. The reference area 412 includes a first number (N₁) of lines of chroma reference samples 402R and a second number (N₂) of lines of luma reference samples 404R above the current coding block 406C. In an example, the reference area 412 includes three rows of chroma reference samples 402R and eight rows of luma reference samples 404R. A buffer (e.g., a buffer memory 252 in FIG. 2B) stores a first set of reference samples 506. A second set of reference samples 508 is generated from the first set of reference samples 506, e.g., by a padding scheme. A plurality of model parameters 410 used in the MHCCP mode are determined for a first chroma sample 402A of the current coding block 406C based on the first set of reference samples 506 and the second set of reference samples 508. A set of one or more luma samples 404 (e.g., samples 404A and 404X in FIG. 4) of the current coding block 406C are combined using the plurality of model parameters 410 to generate the first chroma sample 402A of the current coding block 406C. The image frame 500 or 520 is reconstructed based on the first chroma sample 402A generated from the set of one or more luma samples 404.

Referring to FIG. 5A, in some embodiments, the current coding block 406C is located at the top superblock boundary 504. A topmost row of luma or chroma samples of the current coding block 406C is defined by, and located immediately adjacent to, the top superblock boundary 504. The first set of reference samples 506 stored in the buffer is located at the top superblock boundary 504, and includes a row of luma reference samples 404R, a row of chroma reference samples 402R, or both. The row of luma samples 404R immediately adjacent to the top superblock boundary 504 may be applied (e.g., duplicated) to generate each of seven remaining rows of luma reference samples 404R of the reference area 412. The row of chroma samples 402R immediately adjacent to the top superblock boundary 504 may be applied (e.g., duplicated) to generate each of two remaining rows of chroma reference samples 402R of the reference area 412, thereby constructing the reference area 412 of the current coding block 406C located at the top superblock boundary 504.

In some embodiments, the first set of reference samples 506 may include an entire row of chroma samples 402R or luma samples 404R. Alternatively, in some embodiments, the first set of reference samples 506 a portion of the row of chroma samples 402R or luma samples 404R (e.g., in reference regions 412TL, 412T, and 412TR). In some embodiments, a left reference region 412L and a bottom left reference region 412BL are located within the current coding block 406C. In some embodiments, the left reference region 412L having a first number of lines (e.g., columns), and the top reference region 412T is located external to the current coding block 406C and has a second number of lines (e.g., rows). The first number is equal to or less than the second number.

Referring to FIG. 5B, in some embodiments, the current coding block 406C is located at the left superblock boundary 510. A leftmost column of luma or chroma samples of the current coding block 406C are defined by, and located immediately adjacent to, the left superblock boundary 510. The first set of reference samples 506 stored in the buffer is located at the left superblock boundary 510, and includes a column of luma reference samples 404R, a column of chroma reference samples 402R, or both. The column of luma samples 404R immediately adjacent to the left superblock boundary 510 may be applied (e.g., duplicated) to generate each of seven remaining columns of luma reference samples 404R of the reference area 412. The column of chroma samples 402R immediately adjacent to the left superblock boundary 510 may be applied (e.g., duplicated) to generate each of two remaining columns of chroma reference samples 402R of the reference area 412, thereby constructing the reference area 412 of the current coding block 406C located at the left superblock boundary 510.

In some embodiments, the first set of reference samples 506 may include an entire column of chroma samples 402R or luma samples 404R. Alternatively, in some embodiments, the first set of reference samples 506 a portion of the column of chroma samples 402R or luma samples 404R (e.g., in reference regions 412TL, 412L, and 412BL). In some embodiments, a top reference region 412T and a top right reference region 412TR are located within the current coding block 406C.

In some embodiments not shown, the current coding block 406C is located at a left top corner of the superblock 502. A topmost sample of a leftmost column of luma or chroma samples of the current coding block 406C is defined by, and located immediately adjacent to, both the top superblock boundary 504 and the left superblock boundary 510. The first set of reference samples 506 includes rows of reference samples 402R and 404R (FIG. 5A), rows of reference samples 402R and 404R (FIG. 5B), or both, so does the second set of reference samples 508 generated from the reference samples 506.

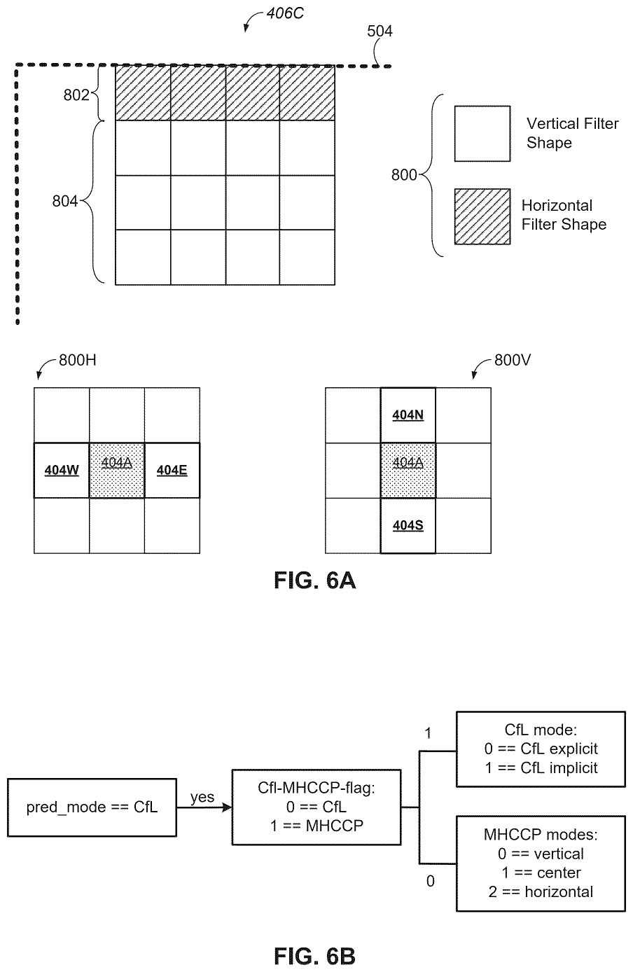

FIG. 6 is a diagram of an example current coding block 404C applying a plurality of filter shapes 800, in accordance with some embodiments. In some embodiments, an MHCCP mode has two different filter shapes 800 including a vertical filter shape 800V and a horizontal filter shape 800H. In some embodiments, a second syntax element 440 (FIG. 4) is signaled into the video bitstream 116 to indicate a selected filter shape selected between the vertical filter shape 800V and the horizontal filter shape 800H. In an example, the second syntax element 440 includes a flag. The selected filter shape has a number of model parameters for prediction (e.g., 5 parameters), and the model parameters are derived for both of the two different filter shapes 800. For the horizontal filter shape 800H, a first luma sample 404A (C), a left luma sample 404W (L), a right luma sample 404E (R), a nonlinear term (E), and an offset term (F) are applied using model parameters c₀, c₁, c₂, c₃, and c₄ to determine a predicted chroma value of the first chroma sample 402A (predChromaVal) as follows:

$$predChromaVal = {c}_{0} C + {c}_{1} L + {c}_{2} R + {c}_{3} E + {c}_{4} F \qquad Equation 2$$

For the vertical filter shape 800V, the first luma sample 404A (C), a top luma sample 404N (T), a bottom luma sample 404S (B), a nonlinear term (E), and an offset term (F) are applied using model parameters c₀, c₁, c₂, c₃, and c₄ to determine a predicted chroma value of the first chroma sample 402A (predChromaVal) as follows:

$$predChromaVal = {c}_{0} C + {c}_{1} T + {c}_{2} B + {c}_{3} E + {c}_{4} F \qquad Equation 3$$

Further, in some embodiments, for each of the horizontal filter shape 800H and the vertical filter shape 800V, the respective five model parameters are derived by Gaussian elimination based on an LMS optimization.

In some embodiments, the right luma sample 404E (R) and the bottom luma sample 404S (B) are not applied in prediction of the first chroma sample 402A in the MHCCP mode. Equations 2 and 3 for predicting the first chroma sample 402A are updated for the horizontal filter shape 800H and the vertical filter shape 800V as follows:

$$predChromaVal = {c}_{0} C + {c}_{1} L + {c}_{2} E + {c}_{3} F \qquad Equation 4$$

$$predChromaVal = {c}_{0} C + {c}_{1} T + {c}_{2} E + {c}_{3} F \qquad Equation 5$$

In some embodiments, the number of the above and the left reference lines are both 3 and 1 padding line in the chroma channels. For 4:2:0 format sequences, the luma channel may require 6 lines and 2 padding lines as the corresponding reference area. In the MHCCP mode, a vertical prediction mode and a horizontal prediction mode are implemented to apply a vertical filter shape 800V and a horizontal filter shape 800H, respectively. For vertical prediction, the first luma sample 404A (C), the top luma sample 404N (T), and the bottom luma sample 404S (B) are combined to generate the first chroma sample 402A (predChromaVal) as follows:

$${predChromaVal}_{h} = {p}_{0}^{h} C + {p}_{1}^{h} L + {p}_{2}^{h} R + {p}_{3}^{h} ( {C}^{2} + m ) + {p}_{4}^{h} m \qquad Equation 6$$

where C is the first luma sample; L and R are the left and right luma samples 404W and 404E, respectively; and m is an offset value, representing a middle value of a pixel intensity (e.g., a middle value of a range of luma sample values). For horizontal prediction, the first luma sample 404A (C), the left luma sample 404W (L), and the right luma sample 404E (R) are combined to generate the first chroma sample 402A (predChromaVal) as follows:

$${predChromaVal}_{v} = {p}_{0}^{v} C + {p}_{1}^{v} T + {p}_{2}^{v} B + {p}_{3}^{v} ( {C}^{2} + m ) + {p}_{4}^{v} m \qquad Equation 7$$

where T and B are the top and bottom luma samples 404N and 404S, respectively. When the current coding block 406C is located at a superblock or coding tree unit boundary (e.g., a top boundary 504, a left boundary 510), one line of reference samples 506 (FIG. 5A) located above the superblock or coding tree unit boundary is available in the buffer for hardware implementation.

In some embodiments, the current coding block 406C includes a first prediction block 802 that is located at the top superblock boundary 504 and a second prediction block 804 that is separated from the top superblock boundary 504 by the first prediction block 802. The horizontal filter shape 800H is applied to combine a set of luma samples 404 to generate a chroma sample 402 of the first prediction block 802. The vertical filter shape 800V is applied to combine a set of luma samples 404 to generate a chroma sample 402 of the second prediction block 804. Stated another way, in some embodiments, the current coding block 406C has a block-level filter shape (e.g., a vertical filter shape 800V) and includes a first prediction block 802 located immediately adjacent to the boundary 504 and a second prediction block 804 that is separated from the boundary 504 by at least one sample (e.g., of the first prediction block 802). In the MHCCP mode, each chroma sample 402 of the first prediction block 802 is reconstructed based on a respective set of first luma samples 404 using a first filter shape (e.g., a horizontal filter shape 800H), and each chroma sample of the second prediction block 804 is reconstructed based on a respective set of second luma samples using the block-level filter shape (e.g., a vertical filter shape 800V) that is distinct from the first filter shape (e.g., a horizontal filter shape 800H).

In some embodiments, the current coding block 406C has a predefined block-level filter shape corresponding to the plurality of model parameters 410. The current coding block 406C is located at a top boundary 504 of a superblock 502 (FIG. 5A), the predefined block-level filter shape is a horizontal filter shape 800H, and the set of one or more luma samples applied to reconstruct the first chroma sample 402A of the current coding block 406C are located on the same row of a first luma sample 404A that is collocated with the first chroma sample 402A.

In some embodiments not shown, the current coding block has a block-level filter shape and includes a first prediction block located immediately adjacent to a left superblock boundary 510 (FIG. 5B) and a second prediction block that is separated from the boundary by at least one sample. In the MHCCP mode, each chroma sample of the first prediction block 802 (e.g., a column of chroma samples) is reconstructed based on a respective set of first luma samples using a first filter shape (e.g., a horizontal filter shape 800H), and each chroma sample of the second prediction block is reconstructed based on a respective set of second luma samples using a block-level filter shape (e.g., a vertical filter shape 800V) that is distinct from the first filter shape.

In some instances, an intra prediction mode is a cross-component prediction mode using a linear model (e.g., a CfL mode), which derive the prediction samples of a first color component using the reconstruction samples of a second color component, while the current block can be a chroma block and the reference block can be a co-located luma block. In some systems, there are two modes for the CfL mode, explicit CfL and implicit CfL. The explicit CfL means the weighting factor or the index to the weighting factor set is signaled explicitly, and the implicit CfL means that the weighting factor is derived at the encoder and decoder side implicitly. For a second example, the intra prediction mode can be cross-component prediction modes using a non-linear model (e.g., MHCCP), which derives the prediction samples of a first color component using the reconstruction samples of a second color component, while the current block can be a chroma block and the reference block can be a co-located luma block. In some systems, there are three MHCCP prediction modes that utilizes the co-located down-sampled luma sample, down-sampled left neighboring of co-located luma sample, down-sampled above neighboring of co-located luma sample, to perform the prediction.

In some embodiments, MHCCP is used to generate the chroma prediction block by a combination of several linear or nonlinear weighted luma samples. The weighting factors are derived based on the neighboring luma reconstructed samples and chroma neighboring reconstructed samples. The reference areas are illustrated in FIGS. 5A and 5B. The reference samples may be L shaped, including bottom left, left, top left, above and above right. There may be three reference lines and columns. In some embodiments, the third line (e.g., furthest from the block) is padded.

In some embodiments, MHCCP mode has three different shapes, which are vertical shape, horizontal shape and center shape. Each mode requires only three parameters for derivation. For the center prediction mode, the prediction mode is as shown in Equation 8.

$${PredVal}_{c} = {c}_{0} C + {c}_{1} E + {c}_{2} F \qquad Equation 8$$

For the left (horizontal) prediction mode, the prediction mode is as shown in Equation 9.

$${PredVal}_{L} = {c}_{0} L + {c}_{1} E + {c}_{2} F \qquad Equation 9$$

For the top (vertical) prediction mode, the prediction mode is as shown in Equation 10.

$${PredVal}_{T} = {c}_{0} T + {c}_{1} E + {c}_{2} F \qquad Equation 10$$

where E and F represent the non-linear component of the center pixel (c²+middle) and the bit-depth offset term (middle), respectively.

As described above, the reference areas in a first color component and/or a second/third color component are used to generate the models for cross component predictions, such as MHCCP. The reference samples are L shaped (e.g., as indicated in FIG. 5C), including bottom left, left, top left, above and above right of the coding block. There may be K reference lines to the above and L columns to the left of the coding block 550. The dark pixels 554 are padded pixels for the reference pixels. An example reference area is illustrated in FIG. 5C. In that example, the number of above and left reference lines are both three. Described below are techniques and methods for reducing the number of samples in the reference areas used for deriving the model parameters.

In some embodiments, a sequence level flag, enable-mhccp, is used to control the MHCCP mode. At the coded block level, the 3-symbol CfL_mode flag may be replaced with two 2-symbol flags. A new syntax element, cfl_mhccp_switch_flag, is added to indicate whether the chroma-from-luma prediction mode is the CfL or MHCCP mode. Additionally, the cfl_mode syntax may be reduced from 3 symbols to 2 and is now used solely to represent CfL prediction modes. When the “enable-mhccp” is on, the signaling logic may be as shown in FIG. 6B. In some embodiments, when enable-mhccp is off, when the prediction mode is CfL, then a CfL mode flag may be signaled to indicate whether a CfL explicit or CfL implicit mode is to be used.

In some embodiments, 2 reference lines are used in the chroma channel and 4 lines plus 2 padding lines are used in the luma channel for MHCCP. In some embodiments, the non-adjacent line in the chroma channel is not used for MHCCP, and only 1 reference line above and to the left in the chroma channel are used. In some embodiments, in the luma channel, 2 lines plus 2 padding lines above the to the left are required to derive the model parameters for MHCCP. In some embodiments, 3 luma lines and 2 padding lines are used.

In some embodiments, for luma padding, considering that the Multiple Reference Line (MRL) mode is using 4 neighboring lines above and to the left for a coding block, the MHCCP mode also utilizes 4 neighboring lines and 1 padding line as the reference region. In some embodiments, downsampling is employed for the luma channel reference samples. For example, downsampling using {1, 2, 1; 1, 2, 1} weights.

Using the example techniques above, the coding gains can be improved. Table 1 below illustrates the improvements to signal-to-noise ratio and coding time based on simulations performed using current designs (e.g., AVM research-v9) with various video data (e.g., representing AOM Test Conditions). The results are reported for all-intra, random access, and low delay configurations.

TABLE 1
Simulation Results

| | | Y-PSNR | U-PSNR | V-PSNR | YUV-PNSR | Enc-time | Dec-time |
|---|---|---|---|---|---|---|---|
| Aspect 1 | AI | 0.00% | −0.34% | −0.30% | −0.03% | 100% | 103% |
| | RA | 0.00% | −0.07% | −0.27% | −0.02% | 101% | 101% |
| | LD | −0.03% | −0.03% | 0.17% | −0.03% | 101% | 101% |
| Aspect 1 + 2 | AI | 0.03% | −0.14% | −0.14% | 0.01% | 100% | 101% |
| | RA | 0.02% | −0.08% | −0.32% | 0.00% | 100% | 100% |
| | LD | −0.08% | −0.41% | 0.17% | −0.09% | 100% | 101% |
| Aspect | AI | 0.00% | −0.37% | −0.20% | −0.02% | 100% | 101% |
| 1 + 2 + luma | RA | 0.00% | −0.30% | −0.03% | −0.01% | 100% | 100% |
| padding | LD | −0.00% | −0.45% | 0.11% | −0.09% | 100% | 101% |

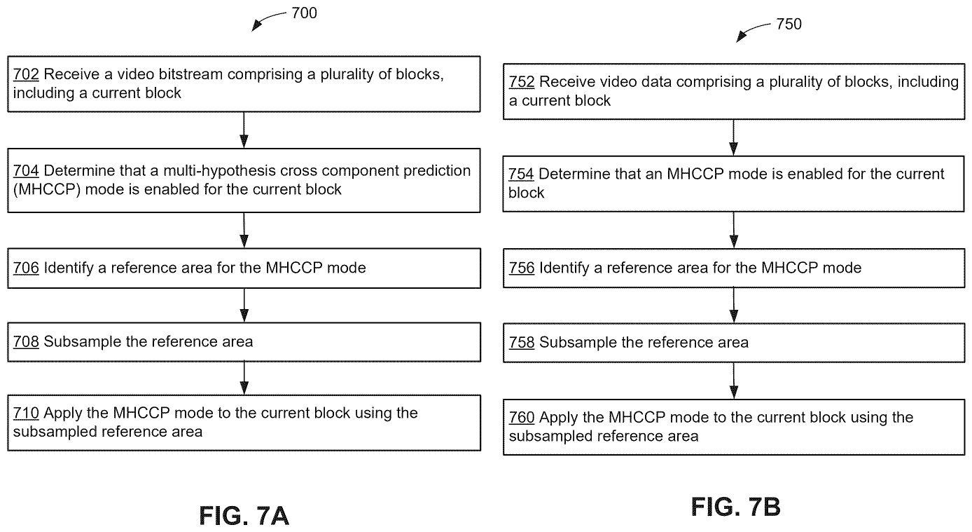

FIG. 7A is a flow diagram illustrating a method 700 of decoding video in accordance with some embodiments. The method 700 may be performed at a computing system (e.g., the server system 112, the source device 102, or the electronic device 120) having control circuitry and memory storing instructions for execution by the control circuitry. In some embodiments, the method 700 is performed by executing instructions stored in the memory (e.g., the memory 314) of the computing system.

The system receives (702) a video bitstream comprising a plurality of blocks, including a current block. The system determines (704) that an MHCCP mode is enabled for the current block. The system identifies (706) a reference area for the MHCCP mode. The system subsamples (708) the reference area. The system applies (710) the MHCCP mode to the current block using the subsampled reference area. In this way, a sub-sampling method may be applied to the reference data collection process to reduce the computational complexity.

In some embodiments, when collecting the data in the reference area, the sub-sampling rate is

$$r = \frac{1}{N} ,$$

which means one sample is picked for every N samples in each row or column or both row and column dimensions, where N is positive integer. In an example, a quincunx down-sampling method is used to reduce the number of samples in the reference area for model derivation process. In another example, the sub-sampling rate is 1/2 for both row and column dimensions. FIG. 5E illustrates an example of such a subsampling where slash-patterned pixels 558 (e.g., 558-1 and 558-2) indicate the sub-sampled pixels.

In some embodiments, when collecting the data in the reference area, the sub-sampling rate rᵢ

$$∈ \{ 0 , \frac{1}{{N}_{i}} \}$$

is varied for different rows/columns, where i is the row or column index. When rᵢ is 0, the i-th row or column picks 0 samples. In some embodiments, the subsampling rate is smaller when the row or column of the reference samples are closer to the current coding block.

For example, the subsampling rate may be 1 for the nearest adjacent reference row/column, and ½ for the second adjacent reference row/column, and 0 for the third reference row/column. FIG. 5F illustrates an example of such a subsampling where slash-patterned pixels 558 (e.g., pixel 558-3) indicate the sub-sampled pixels.

As an example, r₁=0, r₂=1/2, and r₃=1/2, which means the first row and first column pick 0 samples, and the second and the third rows and columns pick one sample every two pixels. FIG. 5G illustrates an example of such a subsampling where slash-patterned pixels 558 (e.g., 558-4) indicate the sub-sampled pixels.

In another example, r₁=0, r₂=1, and r₃=1/2, which means the first row and first column pick 0 samples, the second row and column pick all samples, and the third row and column picks one sample every two pixels. FIG. 5H illustrates an example of such a subsampling where slash-patterned pixels 558 (e.g., 558-5) indicate the sub-sampled pixels.

In another example, r₁=1/2, r₂=1, and r₃=1/2, which means the first and the third rows and columns pick one sample every two pixels, and the second row and column pick full samples. FIG. 5I illustrates an example of such a subsampling where slash-patterned pixels 558 (e.g., 558-6) indicate the sub-sampled pixels.

In some embodiments, the sub-sampling ratio is varied for different rows and/or columns. In some embodiments, the sub-sampling ratio is dependent on the block shape, e.g., the larger side may have a more aggressive sub-sampling ratio. For example, when the ratio of block width and block height is 2:1, the sub-sampling ratio for the row dimension may be ¼, while the column dimension has the sub-sampling ratio of ½.

In some embodiments, different regions (e.g., regions 556 as shown in FIG. 5D) in the reference area have different sub-sampling ratios. For example, the left-bottom and the top-right regions may be skipped and the techniques described above may be applied on only the top left, top, and left regions.

In some embodiments, other techniques, such as the pooling method, down-sampling, low-pass filter, compression or any form of irregular sampling, are used for sub-sampling. In some embodiments, the sub-sampling rate of reference samples for the row and column dimensions depends on the block width, block height, and sample availability. In some embodiments, when one side is larger than the other side by more than 2 times, the reference samples are only selected from the larger side. For example, when the ratio of block width to block height is 4:1 (or 8:1), the “Left” and “Left-Bottom” regions may have no samples to be selected. In another example, when the ratio of block width to block height is 1:4 (or 1:8), the “Top” and “Top-Right” regions may have no samples to be selected.

In some embodiments, when one side is not larger than the other side by 2 more than 2 times, the number of reference samples are distributed evenly to two sides. For example, the “Top-Left”, “Top”, “Top-Right”, “Left”, and “Left-Bottom” regions may have the same number of reference samples to be selected.

In some embodiments, total number of samples is expressed as N to the power of 2, where N is a positive integer. In some embodiments, the subsampling techniques are required to satisfy the requirement that the total number of samples equals N to the power of 2. Some samples may be dropped to meet this condition.

In some embodiments, the total number of reference samples are dependent on the block size. For example, larger size blocks may have more reference samples. In an example, for an 8×8 block, the total number of reference samples are 32; while for a 16×16 block, the total number of reference samples are 64×64.

FIG. 7B is a flow diagram illustrating a method 750 of encoding video in accordance with some embodiments. The method 750 may be performed at a computing system (e.g., the server system 112, the source device 102, or the electronic device 120) having control circuitry and memory storing instructions for execution by the control circuitry. In some embodiments, the method 750 is performed by executing instructions stored in the memory (e.g., the memory 314) of the computing system. In some embodiments, the method 750 is performed by a same system as the method 700 above.

The system receives (752) video data comprising a plurality of blocks, including a current block. The system determines (754) that an MHCCP mode is enabled for the current block. The system identifies (756) a reference area for the MHCCP mode. The system subsamples (758) the reference area. The system applies (760) the MHCCP mode to the current block using the subsampled reference area. As described previously, the encoding process may mirror the decoding processes described herein (e.g., application of cross-component prediction modes). For brevity, those details are not repeated here.

Although FIGS. 7A and 7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In one aspect, some embodiments include a method (e.g., the method 700) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of blocks (e.g., corresponding to a set of pictures), including a current block; (ii) determining that an MHCCP mode is enabled for the current block; (iii) identifying a reference area for the MHCCP mode; (iv) subsampling the reference area; and (v) applying the MHCCP mode to the current block using the subsampled reference area. In this way, a sub-sampling method may be applied to the reference data collection process to reduce the computational complexity.
(A2) In some embodiments of A1, the reference area is a same reference area used for multiple reference line selection (MRLS) for intra prediction of the current block.
(A3) In some embodiments of A1 or A2, subsampling the reference area comprises applying a subsampling rate of 1/N, where N is a number of samples. For example, when collecting the data in the reference area, the sub-sampling rate can be

$$r = \frac{1}{N} ,$$

which means one sample is picked for every N samples in each row or column or both row and column dimensions, where N is positive integer.
(A4) In some embodiments of A3, N is equal to 2. For example, the sub-sampling rate is 1/2 for both row and column dimensions. In some embodiments, total number of samples is M to the power of 2, where M is a positive integer. In some embodiments, the total number of samples is required to equal N to the power of 2, e.g., some samples may need to be dropped to meet this condition. As an example, the total number of reference samples may be dependent on the block size, e.g., larger size blocks may have more reference samples. For example, for an 8×8 block, the total number of reference samples are 32; while for a 16×16 block, the total number of reference samples are 64.
(A5) In some embodiments of A3 or A4, the subsampling rate is different for different portions of the reference area. For example, when collecting the data in the reference area, the sub-sampling rate rᵢ

$$∈ \{ 0 , \frac{1}{{N}_{i}} \}$$

can be varied for different rows/columns, where i is the row or column index. When rᵢ is 0, the i-th row or column picks 0 samples. As an example, the sub-sampling ratio may be varied per row and/or column. For example, different regions may have different subsampling ratios as illustrated in FIG. 5D. As an example, subsampling may be skipped for the left-bottom and/or the top-right regions.
(A6) In some embodiments of A5, the subsampling rate is lower for reference samples closer to the current block and higher for reference samples further from the current block. For example, the subsampling rate is smaller when the row or column of the reference samples are closer to the current coding block. As an example, the subsampling rate is 1 for the nearest adjacent reference row/column, and ½ for the second adjacent reference row/column, and 0 for the third reference row/column. In another example, r₁=0, r₂=1/2, and r₃=1/2, which means the first row and first column pick 0 samples, and the second and the third rows and columns pick one sample every two pixels. In another example, r₁=1/2, r₂=1, and r₃=1/2. In another example, r₁=0, r₂=1, and r₃=1/2, which means the first row and first column pick 0 samples, the second row and column pick all samples, and the third row and column picks one sample every two pixels. In another example, r₁=1/2, r₂=1, and r₃=1/2, which means the first and the third rows and columns pick one sample every two pixels, and the second row and column pick full samples.
(A7) In some embodiments of A5 or A6, the subsampling rate is different for different lines of the reference area. For example, the sub-sampling rate of reference samples for the row and column dimensions depends on the block width, block height, and sample availability. As an example, when one side is larger than the other side by more than 2 times, the reference samples are only selected from the larger side. In one example, when the ratio of block width to block height is 4:1 (or 8:1), the “Left” and “Left-Bottom” regions have no samples to be selected. In another example, when the ratio of block width to block height is 1:4 (or 1:8), the “Top” and “Top-Right” regions have no samples to be selected. In some embodiments, when one side is not larger than the other side by more than 2 times, the number of reference samples are distributed evenly to two sides. For example, the “Top-Left”, “Top”, “Top-Right”, “Left”, and “Left-Bottom” regions may have the same number of reference samples to be selected.
(A8) In some embodiments of any of A1-A7, subsampling the reference area comprises applying a quincunx down-sampling to the reference area. For example, the quincunx down-sampling method may be used to reduce the number of samples in the reference area for model derivation process.
(A9) In some embodiments of any of A1-A8, subsampling the reference area comprises applying a sampling rate that is based on a block size or block shape of the current block. For example, the sub-sampling ratio may be dependent on the block shape, e.g., the larger side may have a more aggressive sub-sampling ratio. As an example, when the ratio of block width and block height is 2:1, the sub-sampling ratio for the row dimension is ¼, while the column dimension has the sub-sampling ratio as ½.
(A10) In some embodiments of any of A1-A9, subsampling the reference area comprises applying irregular sampling to the reference area. For example, other methods, like the pooling method, down-sampling, low-pass filter, compression or any form of irregular sampling.
(B1) In another aspect, some embodiments include a method (e.g., the method 750) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of blocks (e.g., corresponding to a set of pictures), including a current block; (ii) determining that an MHCCP mode is enabled for the current block; (iii) identifying a reference area for the MHCCP mode; (iv) subsampling the reference area; and (v) applying the MHCCP mode to the current block using the subsampled reference area. In some embodiments, the method further includes signaling coded information for the current block.
(B2) In some embodiments of B1, the reference area is a same reference area used for multiple reference line selection (MRLS) for intra prediction of the current block.
(B3) In some embodiments of B1 or B2, subsampling the reference area comprises applying a subsampling rate of 1/N, where N is a number of samples.
(B4) In some embodiments of B3, the subsampling rate is different for different portions of the reference area.
(B5) In some embodiments of B3 or B4, the subsampling rate is different for different lines of the reference area.
(B6) In some embodiments of any of B1-B5, subsampling the reference area comprises applying irregular sampling to the reference area.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A10 and B1-B6 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A10 and B1-B6 above). In some embodiments, a memory or non-transitory computer-readable storage medium stores a video bitstream including any of the features (e.g., syntax and encoded information) disclosed herein.

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
determining that a multi-hypothesis cross component prediction (MHCCP) mode is enabled for the current block;
identifying a reference area for the MHCCP mode;
subsampling the reference area; and
applying the MHCCP mode to the current block using the subsampled reference area.

2. The method of claim 1, wherein the reference area is a same reference area used for multiple reference line selection (MRLS) for intra prediction of the current block.

3. The method of claim 1, wherein subsampling the reference area comprises applying a subsampling rate of 1/N, where N is a number of samples.

4. The method of claim 3, wherein N is equal to 2.

5. The method of claim 3, wherein the subsampling rate is different for different portions of the reference area.

6. The method of claim 5, wherein the subsampling rate is lower for reference samples closer to the current block and higher for reference samples further from the current block.

7. The method of claim 5, wherein the subsampling rate is different for different lines of the reference area.

8. The method of claim 1, wherein subsampling the reference area comprises applying a quincunx down-sampling to the reference area.

9. The method of claim 1, wherein subsampling the reference area comprises applying a sampling rate that is based on a block size or block shape of the current block.

10. The method of claim 1, wherein subsampling the reference area comprises applying irregular sampling to the reference area.

11. A method of video encoding performed at a computing system having memory and one or more processors, the method comprising:
receiving video data comprising a plurality of blocks, including a current block;
determining that an MHCCP mode is enabled for the current block;
identifying a reference area for the MHCCP mode;
subsampling the reference area; and
applying the MHCCP mode to the current block using the subsampled reference area.

12. The method of claim 11, wherein the reference area is a same reference area used for multiple reference line selection (MRLS) for intra prediction of the current block.

13. The method of claim 11, wherein subsampling the reference area comprises applying a subsampling rate of 1/N, where N is a number of samples.

14. The method of claim 13, wherein the subsampling rate is different for different portions of the reference area.

15. The method of claim 13, wherein the subsampling rate is different for different lines of the reference area.

16. The method of claim 11, wherein subsampling the reference area comprises applying irregular sampling to the reference area.

17. A non-transitory computer-readable storage medium storing a video bitstream that is generated by a video encoding method, the video bitstream comprising:
coded information for a plurality of blocks of video data, including a current block; and
wherein the video encoding method comprises:
determining that an MHCCP mode is enabled for the current block;
identifying a reference area for the MHCCP mode;
subsampling the reference area; and
applying the MHCCP mode to the current block using the subsampled reference area.

18. The non-transitory computer-readable storage medium of claim 17, wherein the reference area is a same reference area used for multiple reference line selection (MRLS) for intra prediction of the current block.

19. The non-transitory computer-readable storage medium of claim 17, wherein subsampling the reference area comprises applying a subsampling rate of 1/N, where Nis a number of samples.

20. The non-transitory computer-readable storage medium of claim 19, wherein the subsampling rate is different for different lines of the reference area.
